(19) United States
(12) Patent Application Publication
(10) Pub. No.: US 2010/0017431 A1
(43) Pub. Date: Jan. 21, 2010

(54) Methods and Systems for Social Networking

(76) Inventors: Martin Schmidt, Schiffweiler (DE); Mario Diwersy, Frankfurt (DE)

Correspondence Address: Ballard Spahr LLP, SUITE 1000, 999 PEACHTREE STREET, ATLANTA, GA, 30309-3915, US

(21) Appl. No.: 12/491,825

(22) Filed: Jun. 25, 2009

Related U.S. Application Data
(60) Provisional application No. 61/075,492, filed on Jun. 25, 2008.

(51) Int. Cl. G06F 17/30; G06F 3/048

(52) U.S. Cl. 707/102; 715/764; 707/E17.046

(57) ABSTRACT

Provided are methods and systems for social networking.

### CROSS REFERENCE TO RELATED PATENT APPLICATION

This application claims priority to U.S. Provisional Application No. 61/075,492 filed Jun. 25, 2008, herein incorporated by reference in its entirety.

### SUMMARY

Provided are methods and systems for social networking. In an aspect, provided are methods and systems for social networking, comprising accepting a user registration associated with a unique user, displaying one or more profiles potentially associated with the unique user, wherein each profile was previously constructed, receiving a user selection of the one or more potential profiles, associating the user selected profile with the user, and outputting the selected profile. In another aspect, provided are methods and systems for social networking, comprising determining a plurality of clusters of items, wherein each cluster is associated with a unique entity, determining one or more connections between the pluralities of clusters, constructing a profile for a first unique entity, wherein the profile comprises a first of the plurality of clusters associated with the first unique entity and the one or more connections between the first of the plurality of clusters and the remaining clusters of the plurality of clusters, and outputting the profile. In another aspect, provided are methods and systems for disambiguation, comprising receiving an identifier shared by a plurality of entities, determining a plurality of items associated with the identifier, wherein each of the plurality of items comprises a plurality of attributes, constructing a plurality of clusters of items, wherein each cluster is based on at least one of the plurality of attributes of each item, associating each of the plurality of clusters with a different one of the plurality of entities, and outputting one of the plurality of clusters and the identifier.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is an exemplary user profile;

FIG. 3 is an exemplary social network graph;

FIG. 4 is an exemplary geographic map of a social network;

FIG. 5 is an exemplary method of operation;

FIG. 6 is another exemplary method of operation; and

FIG. 7 is another exemplary method of operation.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In an aspect, provided are methods and systems for social networking. A social network is a social structure comprised of nodes (which can represent an entity, such as an individual, an organization, and the like) that are connected by one or more specific types of interdependency, such as competencies, employment, collaboration, values, visions, ideas, financial exchange, friends, kinship, conflict, trade, web links, genus/species, and the like. The methods and systems provided can automatically construct a profile for an entity. The methods and systems can periodically update the profile based on availability of new information. The profile for an entity can represent, for example, a person's knowledge base as obtained from resumes, publications, employer websites, and the like. In another example, the profile for an entity can represent an organization's knowledge base as obtained from resumes, publications, employer websites, and the like of the organization's members. As another example, a profile for an entity can represent a geographical location as obtained from publications, lawyer/judge relationships based on legal actions, legal venues related to specific causes of actions, an inventor and associated patents, and the like.

The methods and systems provided can further automatically determine one or more connections or interdependencies between entities. For example, a knowledge profile for a first entity constructed from publications can reveal that the first entity co-authored one or more publications with a second entity. The methods and systems can automatically establish a connection between the first entity and the second entity based on co-authorship. In another example, a knowledge profile for a first entity constructed from publications can reveal that the first entity is employed at the same organization and in the same technical field as a second entity. The methods and systems can automatically establish a connection between the first entity and the second entity based on shared employment and technical field. As another example, the methods and systems can indicate lawyers connected through legal actions, inventors connected through common patents, and the like.

Thus, the methods and systems can pre-populate a social network without requiring entity interaction. The methods and systems can present the social network through a website. The website can enable an entity to establish a user account, search for, and claim the entity's profile. The entity can review the profile for accuracy, delete any information used to build the profile that may be inaccurate, and add any information that can be used to increase the accuracy of the profile.

Similarly, the entity can review the connections and interdependencies automatically created to add and/or delete the same.

Entities can utilize the social network to maintain existing contact and find new contacts. An entity can utilize the social network to locate potential collaborators. An entity can utilize the social network to notify contacts of new publications and to be notified of new publications by others. The social network can be used to view collaboration networks of competitors, to determine the shortest path to a potential collaborator or competitor, to identify experts in an entity's network that were active at a certain location, and the like. The social network can be used by attorneys to identify opposing counsel and the cases and judges in the opposing counsel's network. The social network can be used to determine which organizations an inventor filed patent applications with. Furthermore, the methods and systems can be utilized by individuals that are not a part of the social network. For example, a social network created of medical professionals can be used by patients to locate a medical professional regarded as an expert in a particular medical area and/or in a particular geographic location. A social network of lawyers and judges can be used by litigants to determine a lawyer with previous experience with a particular judge.

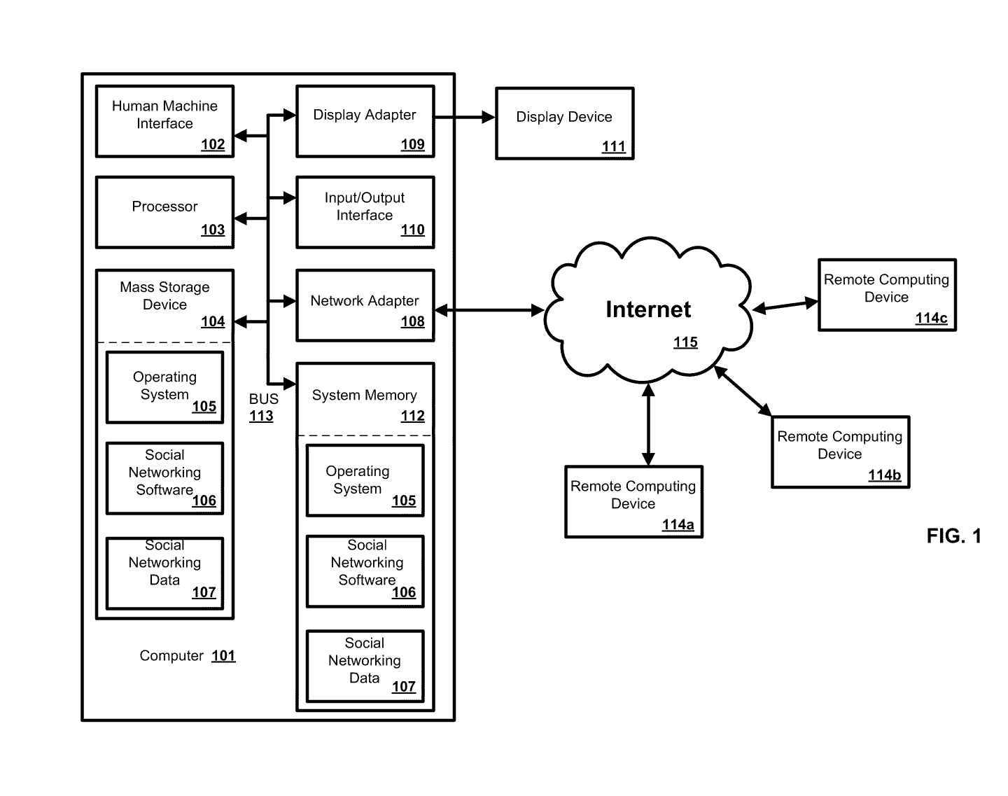

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like. Any of the disclosed methods can be implemented in a system as provided herein.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, social networking software 106, social networking data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media.

Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as social networking data 107 and/or program modules such as operating system 105 and social networking software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and social networking software 106. Each of the operating system 105 and social networking software 106 (or some combination thereof) can comprise elements of the programming and the social networking software 106. Social networking data 107 can also be stored on the mass storage device 104. social networking data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of social networking software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data.

Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In an aspect, the components of the methods and systems for constructing a social network can comprise one or more of, a disambiguation component, a geographical analysis component, an updating component, a profile building component, and a connection component. The constructed social network can be presented, for example, as a world wide web service (website). By way of example, the website can permit users to establish a user account, generate and maintain a profile, add detail to a profile, manually disambiguate a profile, add/confirm/delete connections, search the social network, experience a graphical view of the social network (sub portions and/or the whole network), invite new users to the social network, send and receive messages within the social network, and receive alerts based on various triggers. The user can search, for example, by keyword, by concept, by name, by geographical area, and the like. For example, the user can add detail to a profile such as meta data, geographic data, research data, co-author data, and the like. The graphical view of the social network can be, for example, a graph, a geographic map, and the like. The triggers for alerts can be, for example, new publications in a technical field, by a co-author, by a contact, and the like. In another example, the triggers for alerts can be a new user registering.

In an aspect, a component of the methods and systems can be a disambiguation component. As used herein, disambiguation is resolving conflicts in between multiple words and/or multiple sets of words that appear to be associated with the same entity, concept, item, etc. . . . For example, the methods and systems can perform a search of a publication database, such as Medline/PubMed. The methods and systems can receive an author name (i.e., Smith, J). In this example, there can be several authors with the name Smith, J. The author name can be used to search the publication database and retrieve all publications by Smith, J. The methods and systems can iteratively build clusters with the search results wherein the resulting clusters can be associated with a unique Smith, J. For example, clusters can be built based on the name itself, co-authorship, location, concept (such as Medical Subject Headings (MeSH)), journal, and the like. The iterative clustering can begin with a first publication and compare the first publication to each other publication to determine if there is a similarity above a threshold. If there is a similarity above the threshold, the publications can be grouped into the same cluster. The cluster can then be compared to each other publications, adding to the cluster when a similarity is above the threshold, ending when there are no more publications. This process can be repeated until there are a set of clusters. Each cluster can then be compared to the other clusters, adding clusters to clusters, until there are no clusters that can be added to another cluster. The resulting clusters can represent an unique Smith, J. In an aspect, all name combinations can be used under a frequency of occurrence in the publication database. Previously disambiguated authors can be used for efficiency. For example, a first or subsequent pass of disambiguation can be performed utilizing previously disambiguated co-authors. An aspect of networks includes a node having neighbor nodes. As neighbor nodes are previously disambiguated, the neighbor nodes can be used to disambiguate other nodes.

Provided herein is an exemplary method for disambiguation. The following notation is used. Types are defined in the following text, that are definitions for entities having specific semantic and properties. If type is denoted in the text, it is written in bold. An instance of a type is denoted by an uppercase abbreviation and written italic. Example: There is an instance R of type Record. The value of a property PR of a type instance T is denoted using PR(T) (e.g. the property ID of a Person instance P is denoted ID(P)). A List is a container having non-unique items of one type and is denoted using square brackets, e.g. [1, 2, 3, 3, 2]. The name of a List container is always suffixed by “_List” (e.g. “P_List”: a list of Person items). A Set is a container having unique items of one type and is denoted using curly braces, e.g. {1, 2, 3, 4}. The name of a Set container is always suffixed by “_Set” (e.g. “P_Set”: a set of Person items). The set of all property values of property PR of instances in a list S_List is denoted by
PR(S_List):={v|v ∈ PR(S) ∀ S ∈ S_List}.
   (e.g. the Person type has a property R_Set. The values of R_Set of a single Person instance P is denoted by R_Set(P). The values of R_Set of a set of Person instances P_Set is denoted by R_Set(P_Set).)

The set of all property values of property PR of instances in a set S_Set is denoted by PR(S_Set):={v|v ∈ PR(S) ∀ S ∈ S_Set}.

Subfunctions are also defined. When referring to a subfunction, the name of the subfunction is written in bold. Example: Execute
MergeWorkingItems(W1, W2).

What follows is a description of exemplary types.

Record defines an entity that is associated to a list of Persons. Properties can comprise:

| | |
|---|---|
| ID | The identifier |
| P_List | A list of Person instances |
| M_1 . . . M_n | Arbitrary metainformation. |

Person is an entity describing a person. If a Person instance P is not disambiguated yet, its property ID(P) is undefined and in this case it is identified using properties LN(P) and IN(P). If a Person instance P is already disambiguated, its property ID(P) is defined and this value is used for identification then. Properties can comprise:

| | |
|---|---|
| ID | The id of the instance (optional) |
| LN | The lastname of the person |
| IN | The initials of the person |
| FN | The firstname of the person (optional) |
| R_Set | A set of Record instances that are associated |
| | with that person. |

An instance of type WorkingItem is used while algorithm execution to hold intermediate person information. Each instance WI is created using a Record instance R and a Person instance P ∈ P_List(R) (that means, the person P is one of the persons associated with the record R, P is also called reference person). R is inserted into R_List(WI) and P is associated to RP(WI). While executing of the disambiguation method, WorkingItem instances can be merged together if the corresponding reference persons do very likely define the same “real” person. While merging, most of the properties are unified. This is also the case for the first names and initials. It can happen, that the first names and initials of the same “real” person do not match in the input (e.g. “Mathias” and “Matthias”, or initials “MA” and “M”). Therefore the properties FN_Set and IN_Set are part of type WorkingItem. These two sets contain all occurrences of initials and first names of persons, that were merged into that instance. The property RP (reference person) contains the first name and the initials, that seem to have the most information: these are the strings from FN_Set and IN_Set having maximum length. Example: Given two persons P1 and P2,

FN(P1)=“Matthias Alexander”, IN(P1)=“MA”

FN(P2)=“Mathias”, IN(P2)=“M”.

The method can decide: P1 and P2 are the “same” person=>The corresponding working item instance WI gets the following property values:

FN(RP(WI))=“Matthias Alexander” (the first name of the reference person)

IN(RP(WI))=“MA” (the initials of the reference person)

FN_Set(WI)={“Matthias Alexander”, “Mathias”}

IN_Set(WI)={“MA”, “M”}

The last names must always match exactly, therefore no extra property is necessary (use LN(RP(WI)) ).

The property CP_Set defines persons that do co-occur with at least one of the merged persons in at least one record (so called co-persons). In other words: Because R_List(WI) contains all records of the persons that are merged into the working item instance WI, all person instances in CP_Set must be associated to at least one record in R_List(WI). CP_Set may not contain all co-occurring persons, because filter statements can be defined on co-persons (see setting CoPersonFreqThres_Map). Properties can comprise:

| | |
|---|---|
| RP | A Person instance, this is the reference |
| | person of the instance. |
| R_List | The list of Record instances currently |
| | associated with that person. This equals |
| | R_List(RP) (≈the record list of the |
| | reference person) |
| FN_Set | The set of first names of the reference |
| | persons of all previously merged |
| | WorkingItem instances. Initially it is { |
| | FN(RP) }. |
| IN_Set | The set of initials of the reference persons of |
| | all previously merged WorkingItem |
| | instances. Initially this is { IN(RP) } |
| CP_Set | A set of Person instances (so called co- |
| | persons). It contains a subset of the persons |
| | that are associated to the records in R_List. |
| M_1_Set . . . M_n_Set | The set M_i_Set contains all values of |
| | property M_i of all records in R_List. |

PersonNamePattern is a type used in the method provided describing a name pattern for the reference persons. Trivially, a person is identified using the last name and initials (e.g. “Smith, M”). But it can happen, that the same “real” person is described with alternative initials (e.g. “Smith, M” and “Smith, M A” can be the same person). The first disambiguation step can be performed on the last name and the initials. To consider the case just described, the disambiguation step is not performed by string comparison on last name and initials but by comparison of last name and initials against a pattern. This pattern is called person name pattern. Two persons P1 and P2 are decided as “not the same”, if P1 and P2 do not match the same person name pattern, or inversely said: P1 and P2 can be “the same”, if P1 and P2 do match the same person name pattern.

The type PersonNamePattern defines such a person name pattern. It consists of property LN (the lastname, that means “matching persons” P1 and P2 must have the same last name) and of property IN_Set (the initials possibilities, that means “matching persons” P1 and P2 must have initials that occurr in IN_Set).

Example: An PersonNamePattern instance PNP has properties

LN(PNP)=“Smith” and

IN_Set(PNP)={“M”, “MA”, “ME”, “MAE”}

If person P1 matches the pattern, i.e.

LN(P1)=“Smith” and IN(P1) ∈ {“M”, “MA”, “ME”, “MAE”}

but Person P2 does not match the pattern, i.e.

LN(P2) ≠ “Smith” or IN(P2) ∉ {“M”, “MA”, “ME”, “MAE”}

then the method can decide, that P1 and P2 can not be the same “real” person. Properties can comprise:

| | |
|---|---|
| LN | The last name pattern. All matching reference persons RP |
| | must fulfill LN(RP) = LN |
| IN_Set | A set of initial strings. All matching reference persons RP |
| | must fulfill IN(RP) ∈ IN_Set |

Settings can be defined, that can be used in the method, but as recognized by one of ordinary skill in the art, should be adapted to the actual problem.

The setting Metainformation Class Set (MC_Set) defines the set of M_Class instances for the actual case. Each instance of type M_Class defines an ordered list containing special WorkingItem properties. These properties are Prop Set={CP_Set, W, M_{—}1_Set . . . M_n_Set}. Each Prop ∈ Prop_Set is associated with exactly one M_Class instance (note: the property itself is classified into M_Class instances, not the values of the properties). All properties in one M_Class instance MC depend on each other in a transitive way. That means, if MC has entries M_1, . . . M_k then a value v1 for M_1 induces a value v2 for M_2 that induces a value v3 for M_3 and so on. Example: MC_Set contains an M_Class instance Location. Location contains the WorkingItem properties related to the Record metainformation City, State and Country. Then a City value implies the State value and the State value implies the Country value: Suppose the City value is “Houston”=>State value is “Texas”=>Country value is “U.S.A.”

The properties CP_Set and M_{—}1_Set . . . M_n_Set of a working item can be divided into several classes, so called Match Indication Strength classes MIS_1 to MIS_n. MIS_1 defines properties that have strong impact on record comparison, MIS_2 properties have less and so on. That means, if two records R1 and R2 with reference persons P1 and P2 have common values for a property M with corresponding working item property M_Set∈MIS_1, then this is a strong indication that P1 and P2 denote the same “real” person. If M_Set ∈ MIS_n, then it is only a weak indication that P1 and P2 are the same “real” person.

The settings can also comprise MIS thresholds (T_MIS_1 . . . T_MIS_n). In the method, for each Match Indication Strength MIS_i the number of matching property values of two WorkingItems is computed (the so called Rank_i). If Rank_1<T MIS_i for any i, the two WorkingItems are decided as not matching (≈the two reference persons do not denote the same “real” person).

Disambiguation Loop Count (DLC) can be the maximum number of passes in the main loop of function Disambiguate.

Person Name Pattern Filter (PNPF_1 . . . PNPF_m) is a setting that defines, how often the main method loop is executed and which person name patterns are used in the current pass. Each loop pass has a Person Name Pattern Filter PNPF_i (i ∈ [1,m]). Within each loop, person name pattern instances are computed. If the filter PNPF_i is false for a person name pattern instance, the execution is skipped for this pattern.

It is necessary, that all occurring person name pattern instances are valid once and exactly once. In other words: Each occurring pattern must be valid in exactly one pass of the main loop. For all passes of the main algorithm loop except the first one, the co-person information can be retrieved from the already disambiguated person list. This increases the quality of the results. The map CoPersonFreqThres_Map contains—depending on the number of records examined in the main loop of function Disambiguate—a frequency threshold for the co-person usage. If a co-person is associated with more records than allowed, it is skipped for the co-person computation.

An exemplary disambiguation method can comprise an input of R_Set, a set of Record instances. The exemplary disambiguation method can comprise an output of P_Set, a set of Person instances, each person referring to a set of records from R_Set, with very high probability that all records of R_Set(P) (P ∈ P_Set) are associated with the same person and a high probability that all records “really” associated with the same person are in a single R_Set(P) (P ∈ P_Set).

The method for disambiguation can comprise:
PNP_Set={PNP|∃ P ∈ P_List(R_Set): LN(PNP)=Setting
N(P) [symbol] IN_Set(PNP)={IN(P)}}Computing a set PNP_Set containing PersonNamePattern instances that matches all co-occurring lastname and initials occurrences in P_List(R_Set)

Setting PNP_Set=Execute PreprocessInputNames(R_Set, PNP_Set) Merge entries in PNP_Set. As an example: The preprocess can merge items of PNP_Set depending on the lastname, the first character of the initials and on statistical information.

Setting P_Set={ }. The result set, empty at the beginning.

Then, for Each PNPF_i:
Setting_P_Set_i={ }. The intermediate result set for loop i. For Each PNP ∈ PNP_Set
   i. If PNPF_i(PNP)=false :Continue. If the filter for PNP fails, continue with the next PNP
   ii. Setting R_Set(PNP)={R ∈ R_Set|∃ P ∈ P_List(R) with LN(P)=LN(PNP) [symbol] IN(P) ∈ IN_Set(PNP)}. Computing all records having an associated person matching the PersonNamePattern PNP instance.
   iii. Setting NewP_Set=Execute Disambiguate(PNP, R_Set(PNP), P_Set)
      Disambiguating all persons matching the PersonNamePattern instance PNP and assign the disambiguated persons to NewP_Set.
   iv. Setting P_Set_i=P_Set_i ∪ NewP_Set. Extending the intermediate result set for loop i by the just disambiguated persons.

Setting P_Set=P_Set ∪ P_Set_i Extending the overall result set by the intermediate result set of loop i.

Returning P_Set.

An exemplary Disambiguate function can have input such as PNP, the current PersonNamePattern instance; R_Set(PNP) Set of Records with all records having at least one person matching the PNP instance; and P_Set, Set of Person, the set of already disambiguated persons. The exemplary Disambiguate function can have output such as NewP_Set, set of Person instances, each person referring to a set of records from R_Set(PNP).

The exemplary Disambiguate function can comprise the following steps. Setting RecordCount=len(R_Set(PNP)). The RecordCount defines the number of records having at least one person matching the PNP instance. It is used later in the rank re-computation.

Setting WI_List=[ ]. Create the working item list. The list is filled in the next step.

For Each R ∈ R_Set(PNP):
a. Creating WI
b. Set R_List(WI)=[R]
c. Setting RP(WI)=P with P ∈ P_List(R) with LN(P)=LN(PNP) A IN(P) [symbol] IN_Set(PNP)
d. Setting FN_Set(WI)={FN(RP(WI))}
e. Setting IN_Set(WI)={IN(RP(WI))}
f. Setting M_i_Set(WI)=M_i(R)} for all properties M_i of type Record
g. If P_Set={ }
   Setting CP_Set(WI)={P ∈ P_List(R)|P ≠ RP(WI) [symbol] CoPersonCondition(P, R_Set(PNP))=true.
There are no disambiguated persons yet, so use the persons also associated with R and fulfilling a given condition.
Else:
   Setting
CP_Set(WI)={P ∈ P_Set|P ≠ RP(WI) [symbol] R_Set(PNP) ∩R_Set(P) ≠{ }}. There are disambiguated persons, so use these for the co-person computations.
h. Appending WI to WI_List.

Executing DisambiguateByFirstname(PNP, WI_List).

Sorting WI_List by len(FN(WI)) desc. All WI with a first name are at the beginning of WI_List.

For i=1 To DLC.
a. Setting AnyWI_merged=false. Describes, if any WI was merged while this loop pass.
b. For Each WI in WI_List:
   i. Do
      Setting WI_merged=ExecuteEntry(WI)
      If WI_merged=true:
         Setting AnyWI_merged=true
   While WI_merged=true
c. If AnyWI_merged=false:
   Break. No more WI to merge, break execution.

Setting NewP_Set={RP ∈ RP(WI_List)}.

For Each P ∈ NewP_Set: Setting ID(P)=new ID. Set the id of the new disambiguated person to a unique value.

Returning NewP_Set.

Provided is an exemplary CoPersonCondition(CP, R_Set(PNP)) function. The function checks depending on the length of the current record set, if the person CP may be used for the co-person computation or not. The steps can comprise the following.

SettingFreqThres=CoPersonFreqThres_Map[len(R_Set(PNP))] CoPersonFreqThres_Map is a setting, see the settings chapter.

Setting Freq(CP)=|}R ∈ R_Set|∃P ∈ P_List(R) with LN(P)=LN(CP) [symbol] IN(P)=IN(CP)}

If Freq(CP)≧FreqThres:

Returning true

### Else:

Returning false

Provided is an exemplary ExecuteEntry(WI_1) function.

Setting WI_merged=false.

For Each WI_2 ∈ WI_List \ {WI_1}: If CompareEntries(WI_1, WI_2):
i. MergeEntries(WI_1, WI_2).
ii. Removing WI_2 from WI_List.
iii. Setting WI_merged=true.

Returning WI_merged.

Provided is an exemplary CompareEntries(WI_1, WI_2) function. The steps can comprise the following.

If Not (IN_Set(WI_1) [symbol] IN_Set(WI_2) [symbol] IN_Set(WI_2) [symbol] IN_Set(WI_1)): Return false. The initials of the two persons cannot match (e.g. “FM” and “FG”).

For each MIS₁₃ k (k=1 to n):
a. Setting M_Set_Inter sec t=M_Set(WI_1) ∩ M_Set(WI_2) with M_Set ∈ MIS_k. Compute for each M_Set in MIS_k the matching values of WI_1 and WI_2.
b. Setting
   Rank_k={MC ∈ MC_Set|∃ M_Set ∈ MIS_1 ∪ . . . ∪ MIS_k with M_Set_Intersect ≠ { }}| The Rank_k is the number of property classes having at least one property M_Set such that WI_1 and WI_2 have a common value for that property M_Set. E.g. if WI_1 and WI_2 do have one same City value and therefore also one same Country value, it is counted only once (because City_Set and Country_Set are in the same M Class instance Location).
c. Setting Rank_k=RecomputeRank(k, Rank_k, RecordCount). This is a highly case dependent recomputation of the rank.
d. If Rank_k<T_MIS_k: Returning false. If the computed rank for that Match Indication Strength class is less than the needed threshold for that class, decide the items as not matching.

Returning true. All computed ranks were sufficient, so WI_1 and WI_2 denote likely the same “real” person.

Provided is an exemplary RecomputeRank(k, Rank_k, RecordCount) function. This function is highly case dependent, this is an example implementation of how to use the information.

If FN_Set(WI_1) ≠ { } [symbol] FN_Set(WI_2) ≠ { }: Both WI do have at least one first name. Setting FN_Set_Intersect=FN_Set(WI_J) ∩ FN_set(WI_2)

[Reseting Rank_k depending on k, RecordCount and the content of FN_Set_Intersect]

### Else:

[Reseting Rank_k depending on k and RecordCount]

Provided is an exemplary MergeEntries(WI_1, WI_2) function. This function merges the data of WI_2 into WI_1. The steps can comprise the following.

Merge RP1:=RP(WI_1) and RP2:=RP(WI_2):
a. If len(FN(RP2))>len(FN(RP1)): Set FN(RP1)=FN(RP2).
b. if len(IN(RP2))>len(IN(RP1)): Set IN(RP1)=IN(RP2).
c. Set R_Set(RP1)=R_Set(RP1) ∪ R_Set(RP2).

Set R _List(WI_1)=R_List(WI_1)+R_List(WI_2).

Set CP_Set(WI_1)=CP_Set(WI_1) ∪ CP_Set(WI_2).

Set IN_Set(WI_1)=IN_Set(WI_1) ∪ IN_Set(WI_2).

Set FN_Set(WI_1)=FN_Set(WI_1) ∪ FN_Set(WI_2).

Set M_i_Set(WI_1)=M_i_Set(WI_1) ∪ M_i_Set(WI_2) ∀ M_i of R.

Provided is an exemplary DisambiguateByFirstname method. The method can comprise input such as PNP, the PersonNamePattern instance and WI_List, a list of WorkingItem instances. The method can comprise output such as WI_List, the list of WorkingItem instances, each one representing a person. WI instances from the input list having strong name association are merged together into a single WI. The method can comprise settings such as RatioThreshold, a value that defines a threshold: If the computed ratio of the first name frequency and last name frequency exceeds the RatioThreshold, the first name-last name correlation is so particular, that it is likely that all WI having that correlation are associated to the same “real” person=>the WI are merged together. The steps of the method can comprise the following.

Setting
LastNameCount=|[P ∈ P_List(R_Set)|LN(P)=LN(PNP)]|
   The number of persons in the person lists of all records having the given lastname.

Setting LastNameCount(WI_List)=|WI_List)|

LastNameCount is restricted on the reference persons of the WI_List, this is equal to: setting
LastNameCount(WI_List)={RP ∈ RP(WI_List)|LN(RP)=LN(PNP)}|.

Setting LastNameRatio=LastNameCount(WI_List)/LastNameCount.

For Each FN ∈ {FN|∃ RP ∈ RP(WI_List) with FN(P)=FN}.
a. Setting
   FirstNameCount(FN)=|[P ∈ P_List(R_Set)|FN(P)=FN]|. The number of persons in the person lists of all records having the given first name.
b. Setting FirstNameCount(WI_List, FN)=|[RP ∈ RP(WI_List)|FN(RP)=FN]|. The number of records from WI_List having a reference person with the given firstname.
c. Setting FirstNameRatio(FN)=FirstNameCount(WI_List,FN)/FistNameCount(FN)
d. IfFirstNameRatio(FN)+LastNameRatio>RatioThreshold: MergeWorkingItemByFirstName(FN). The firstname-lastname correlation is so particular, so merge all WI having that correlation.

Provided is an exemplary MergeWorkingItemByFirstName(FN) function. The steps can comprise the following.

Searching first WI_1 in WI_List with FN(RP(WI_1))=FN

For all other WI_2 ∈ WI_List\ {WI_1}:

Disambiguate.MergeEntries(WI_1, WI_2)

Removing WI_2 from WI_List

Provided is an exemplary PreprocessInputNames method. Depending on the case, other approaches are possible and the preprocess step can be omitted completely. The method can comprise input such as R_Set, a set of Record instances and PNP_Set, a set of PersonNamePattern instances, each instance PNP having len (IN_Set(PNP))=1 (exactly one initials entry). The method can comprise output such as PNP_Set, a set of PersonNamePattern instances corresponding to the input PNP_Set, but comparable entries merged together into a single entry. The steps of the method can comprise the following.

For Each LN ∈ LN(PNP_Set):
a. Setting
   IN_Set(LN)={IN|IN ∈ IN_Set(PNP) with PNP ∈ PNP_Set ∈ LN(PNP)=LN}. The set contains all initials occurring together with current last name in the records.
b. For Each FC ∈ {FirstChar(IN) | IN ∈ IN_Set(LN)}: Iterate over all first characters of the initials.
   i. If FC ∉ IN_Set(LN): Continue. If there is no single character initial, do not merge.
   ii. Setting
      IN_Set(LN, FC)={IN ∈ IN_Set(LN)|FirstChar(IN)=FC} This set contains all initials having the current prefix character occurring with the current last name.
   iii. For Each IN ∈ IN_Set(LN, FC): Set R_Set(LN,IN)={R ∈ R_Set|∃ P ∈ P_List(R) with LN(P)=LN [symbol] IN(P)=IN}. For each of the initials identify the records having a person with that initials and the current last name.
   iv. Set MaxRecordCount=Max(len(R_Set(LN, IN)) with IN ∈ IN_Set(LN, FC)). Identify the initials with the maximum number of records.
   v. Set SumRecordCount=Sum(len(R_Set(LN,IN)) with IN ∈ IN_Set(LN,FC)). Accumulate the number of all records.
   vi. If MergeCondition(MaxRecordCount, SumRecordCount)=true Depending on the information retrieved decide, if the initials with the common prefix are merged together into a single pattern instance or not.
      1. Remove All PNP From PNP_Set
         with:
         LN(PNP)=LN [symbol] (IN_Set(PNP) n IN_Set(LN,FC)) ≠ { }
      2. Insert new PNP To PNP_Set with LN(PNP)=LN [symbol] IN_Set(PNP)=IN_Set(LN, FC). Replace the former PNP instances with a new one containing all initials of the removed ones.

Returning PNP_Set.

The MergeCondition(MaxRecordCount, SumRecordCount) function is completely case dependent and is therefore omitted here.

In an aspect, a component of the methods and systems can be a geographical analysis component. As used herein, geographical analysis can comprise determine an organization, city, state, country, region, continent, and the like associated with an entity, concept, item and the like. Geographical analysis can be performed by examining meta data associated with an entity, concept, item and the like. Depending on the structure of the metadata, regular expressions can be used to extract geographical information. Extracted geographical information can be compared to a geographic database to confirm accuracy.

By way of example, in PubMed, articles are stored with an array of metadata, including an “Affiliation” field. According to the PubMed Help file, the “Affiliation [AD] Can include the institutional affiliation and address (including e-mail address) of the first author of the article as it appears in the journal.”

The methods and systems disclosed can use a geographical database of organizations involved in biomedical research and can use the database to identify the organization(s) specified in the PubMed field “Affiliation”.

The PubMed field “Affiliation” field typically comprises the following information bits in this order: sub-organization, organization, city, subdivision, country, e-mail address.

Affiliations may deviate from this general format in different ways. Institutional or geographical information may be partly or totally absent, or be specified in a different order. Additional information may be provided, e.g. sub-sub-organizations, zip codes, street names and numbers, room numbers, and the like. E-mail-addresses are often omitted.

Examples of the Affiliation:

| PubMed ID | Affiliation |
|---|---|
| 17205626 | “Department of Ophthalmology, Medical College of Wisconsin, |
| | Milwaukee, USA.” |
| 17203862 | “Institute of Organic Chemistry, lódz, University of Technology, |
| | Zeromskiego 116, 90-924 lódz, Poland.” |
| 17203824 | “Department of Radiology and Imaging, Nepal Medical College and |
| | Teaching Hospital, Jorpati, Kathmandu, Nepal, kedibi@yahoo.com” |
| 17203800 | “Section of Cardiology, Department of Medicine, University of |
| | Puerto Rico School of Medicine, San Juan, PR.” |

In approximately two out of 100 affiliations, two or more affiliations are specified, in most cases set apart by a semicolon. About 95% of the affiliations are completely or predominantly in English. Only about 1% exhibit spelling errors.

By way of example, in the geographical database, organizations can be represented in a two-tiered structure, as simple organizations or as sub-organizations of organizations. Unique identifiers can be assigned to each organization and all of the organizations associated sub-organizations.

Examples:

| Org_ID | Dep_ID | Org | Dep |
|---|---|---|---|
| 01 | 01 | Saint | |
| | | Lawrence | |
| | | University | |
| 02 | 01 | Cornell | |
| | | University | |
| 02 | 02 | Cornell | Weill Medical |
| | | University | College of Cornell |
| | | | University |

In an aspect, a location can be defined as a locality (estate, village, city) in a province (or state) in a country. Each location can be associated with a unique identifier.

Examples:

| Loc_ID | City | Subdivision | Country |
|---|---|---|---|
| 26448 | Orange | New South | Australia |
| | | Wales | |
| 24944 | Winnipeg | Manitoba | Canada |
| 26842 | Charleston | South | USA |
| | | Carolina | |

Each (sub-)organization can be connected to exactly one location. This implies that only organizations that can be located are recorded. Different sites of organizations can be represented as different sub-organizations. For example. the University of Toronto as shown below.

| | | | | | | Sub- | |
|---|---|---|---|---|---|---|---|
| Org_ID | Dep_ID | Org | Dep | Loc_ID | City | division | Country |
| 01 | 01 | Charles | | 26448 | Orange | New | Australia |
| | | Sturt | | | | South | |
| | | University | | | | Wales | |
| 02 | 01 | Cornell | | 28201 | Ithaca | New | USA |
| | | University | | | | York | |
| 02 | 02 | Cornell | Weill | 25236 | New | New | USA |
| | | University | Medical | | York | York | |
| | | | College of | | | | |
| | | | Cornell | | | | |
| | | | University | | | | |
| 03 | 01 | University | | 25008 | Toronto | Ontario | Canada |
| | | of Toronto | | | | | |
| 03 | 02 | University | | 30161 | Scarborough | Ontario | Canada |
| | | of Toronto | | | | | |

Organizations and locations can be referred to in different ways. For example, the original name of a university may be used (“Vrije Universiteit Brussel”), or it may be translated into English (“Brussels Free University”), diacritics may be omitted for convenience (e.g. “Sao Sebastiao” for “São Sebastião”), the name “University of California at Los Angeles” may be shortened to “UCLA”, and so forth. Different names can be gathered that are in use for organizations, cities, countries etc., classified by type, in a central table of “aliases”.

The base of the geographical database can be automatically assembled from publicly available databases, such as databases of universities, research sites, hospitals, companies, and so forth. The entities found in PubMed affiliations can be filtered out. The methods and systems can determine the identity of unknown organizations in PubMed affiliations. The methods and systems can make use of a multilingual, hierarchically ordered collection of key descriptors for organizations and sub-organizations. An example of the collection is as follows:

| | | | | |
|---|---|---|---|---|
| depart* | labor* | universit* | hospital* | med*centr* |
| abteil* | . . . | school | infirmary | egyetem |
| . . . | | clinic* | ziekenhuis | haskoli |
| | | . . . | sanator* | univers* |
| | | | . . . | . . . |

Using these keywords and the most popular order and structuring of information in PubMed affiliations, the methods and systems provided can extract the organization and—if specified—the first-order sub-organization from the affiliation string.

The methods and systems can identify organizations in the PubMed affiliation. Both names of organizations and names of locations are often ambiguous. For example, there are quite a few universities referred to as “National University” and probably hundreds of “City Hospitals”, likewise, there's a Glasgow in the UK and four more in the USA, “Washington” can refer to one of several cities or to a US state, and so forth. At the same time, geographical names cannot always be taken as denominating an organization's location. Geographical names also occur in street names (California Avenue, Albany Street) or in organization names (Georgia State University, University of Columbia).

A method can be used that collects the names in an affiliation filed that appear to be names of organizations, sub-organizations, cities, subdivisions or countries and then determine a logical combination. Another method can be used that employs other strategies. The strategies can comprise exploiting the fact that affiliations are typically well-structured (by commas) and generally present the same kinds of information in roughly the same order and reading in information such that already determined information assists with narrowing down remaining possibilities.

Before commas can be used to identify “information fields” of an affiliation, two facts should be considered. Besides separating welcome information like organization, city and so forth, commas can be part of organization names, for example, in “University of California, Los Angeles”, “Alpha Genesis, Inc.”, “Cravath, Swaine & Moore”, and they can enclose zip codes or house numbers. To address the issue of commas in organization names, a search for organizations can be performed (and sub-organizations) before the structuring of the affiliation. House numbers and zip-codes are relatively easy to identify based on length. For all the organizations in the geographical database it can be determined whether the organizations are mentioned in an affiliation. Following the principle of longest match, organization names can be sorted by length. For example, from longer to shorter names. When a name is found, it can be made unavailable to the rest of the organization search. Thus prohibiting two organizations, with similar names being recognized by the same string. For example, preventing the “Universidad Central de Venezuela” and the “Universidad Central” (in Bogota) from be recognized in the string “Universidad Central de Venezuela”.

If an organization name is not found in the affiliation that matches a name in the geographical database, both the names and the affiliation can be normalized, including for example, the deletion of commas and prepositions and the replacement of diacritics. The search can then be repeated.

For all the organizations found, it can be determined whether any of their sub-organizations are known, and if so, it can be determined whether the sub-organization is specified in the affiliation. The organizations (and associated sub-organizations) found can be maintained.

E-mail address contained within the affiliation can also be processed. For example, if an e-mail address is specified at all, the email address typically occurs at the end of the affiliation. E-mail addresses can be located and stored.

Now, the affiliation can be divided into fields by means of commas and semicolons. Examples:

| | | | | |
|---|---|---|---|---|
| Department of | Medical | Milwaukee | | USA |
| Ophthalmology | College of | | | |
| | Wisconsin | | | |
| Institute of | lódz University | Zeromskiego 116 | 90-924 lódz | Poland |
| Organic | of Technology | | | |
| Chemistry | | | | |
| Section of | Department of | University of | San Juan | PR |
| Cardiology | Medicine | Puerto Rico School | | |
| | | of Medicine | | |
| Department of | Nepal Medical | Jorpati | Kathmandu | Nepal |
| Radiology and | College and | | | |
| Imaging | Teaching | | | |
| | Hospital | | | |

The methods and systems provided herein can extract other geographical information such as city and country. Typically, the affiliation specifies a city and a country in this order with a dividing character between them.

To reduce possible meanings of geographical names, countries can be determined initially, then for a subdivision, and eventually for a city. The affiliation can thus be read moving leftwards.

Whenever an ambiguous geographical name is determined, the meaning of the name can be disambiguated by, for example, matching the name with the other geographical information found in the affiliation (see below). If unsuccessful, the ambiguous information can be stored.

If geographical information is determined that is inconsistent with what was previously determined (for example, a city which is not located in the identified country), the search can continue until a consistent result is determined. If a consistent result is determined, the consistent information can be stored. If a consistent result is not determined the involved fields can be marked as inconsistent.

If a geographical name is determined of the type desired, the rest of the field containing that name can be analyzed. If information typically co-occurring with geographical names (like numbers and codes) is determined, a function can be assigned to the field, e.g. “country field”, “subdivision field” and so forth. Accordingly, a field reading “I-20141 Italy” will be marked a “country field”, whereas a field containing the string “Inter-American University of Puerto Rico” will not. Fields that have been assigned a geographical “function” can be ignored in subsequent search processes. This is to prohibit, for example, a string such as “New York” from being interpreted both as a city and a state.

By way of example, begin with the end of the affiliation and search for a country name, moving left field by field. When a country name is found, it can be stored, the field contents analyzed and, if the country name is the main information in the field, mark it as a “country field”. If, in the country located, addresses usually contain a specification of a subdivision, like in Canada, the US, or Brazil, the search can move back to the right of the affiliation and start searching for a subdivision, ignoring the “country field”.

If a name is determined that could either be a subdivision or a city (for example, “Washington”), at attempt can be made to find a second city name. If a city located in the state of Washington is found, that city can be stored and the state of Washington. If no city located in the state of Washington is found, the affiliation's organization could be located either in Washington (city) or in Washington (state).

If a name is found that is unequivocally the name of a subdivision, it can be determined whether the name fits the country previously found. If so, both the subdivision and the country can be stored. If not, an attempt can be made to find a suitable subdivision. If no suitable subdivision is found, the inconsistent subdivision can be stored, and both fields marked as inconsistent. The search can continue to look for a city.

If the country found does not have subdivisions or usually does not mention subdivisions, the search can proceed to look for city names, proceeding much like that for subdivisions. If no country is located, a search for a subdivision can be performed, referring to previously determined inconsistencies and ambiguities.

The information stored in the geographic database about the location(s) of the (sub)organization(s) can be compared to the geographic information extracted from the affiliation. Consistent results allow for filtering out one (sub)organization, allowing the (sub)organization to be assigned to the affiliation.

In an aspect, the methods and systems can comprise an updating component. The information used to build profiles can be extracted from various sources. Some sources can be periodically updated. The methods and systems provided can regularly access the updated sources to adjust profiles created previously and to determine new profiles to create. Updating pre-calculated clusters can be performed using the same process as the initial clustering, only the process can preload the existing clusters before executing. During this process new assignments to existing clusters can be made, new clusters can appear and clusters can be merged as a result of new data.

In an aspect, the methods and systems can comprise a profile building component. Profiles can be generated, for example, by aggregating meta information associated with items (for example, publications). The metadata can be concepts, locations, journals, and the like. The appearances of metadata can be counted and ranked by frequency. An IDF correction (Inverse Document Frequency) can be applied to push specific concepts up and very common concepts down in the profile.

In an aspect, the methods and systems can comprise a connection component. Connections can be predefined, for example, a coauthor relationship which is defined by the underlying publications, opposing counsel relationship or attorney—judge experience defined by published legal opinions, coinventor relationships defined by patent applications or patents, and the like. Connections can also be generated manually. Connections can be bi-directional. Connections can be uni-directional. Connections can identify, for example, friends, business relations, professors, students, etc. . . .

As mentioned previously, the constructed social network can be presented, for example, as a world wide web service (website). By way of example, the website can permit users to establish a user account, generate and maintain a profile, add detail to a profile, manually disambiguate a profile, add/confirm/delete connections, search the social network, experience a graphical view of the social network (sub portions and/or the whole network), invite new users to the social network, send and receive messages within the social network, and receive alerts based on various triggers. The user can search, for example, by keyword, by concept, by name, by geographical area, and the like. For example, the user can add detail to a profile such as meta data, geographic data, research data, co-author data, and the like. The graphical view of the social network can be, for example, a graph, a geographic map, and the like. The triggers for alerts can be, for example, new publications in a technical field, by a co-author, by a contact, and the like. In another example, the triggers for alerts can be a new user registering. Exemplary activities a user can perform through the website can comprise trend visualization:

trends of concepts in a person, organization or city profile; trends of coauthors of a particular person; trends of activity places a particular person; and the like. Other activities can comprise, for example, alerts triggered by certain trends, discussion forums for experts, blocks for individuals or organizations, and identification of research centers in a network graph for a particular concept (clusters of people around a center e.g. a professor), and the like.

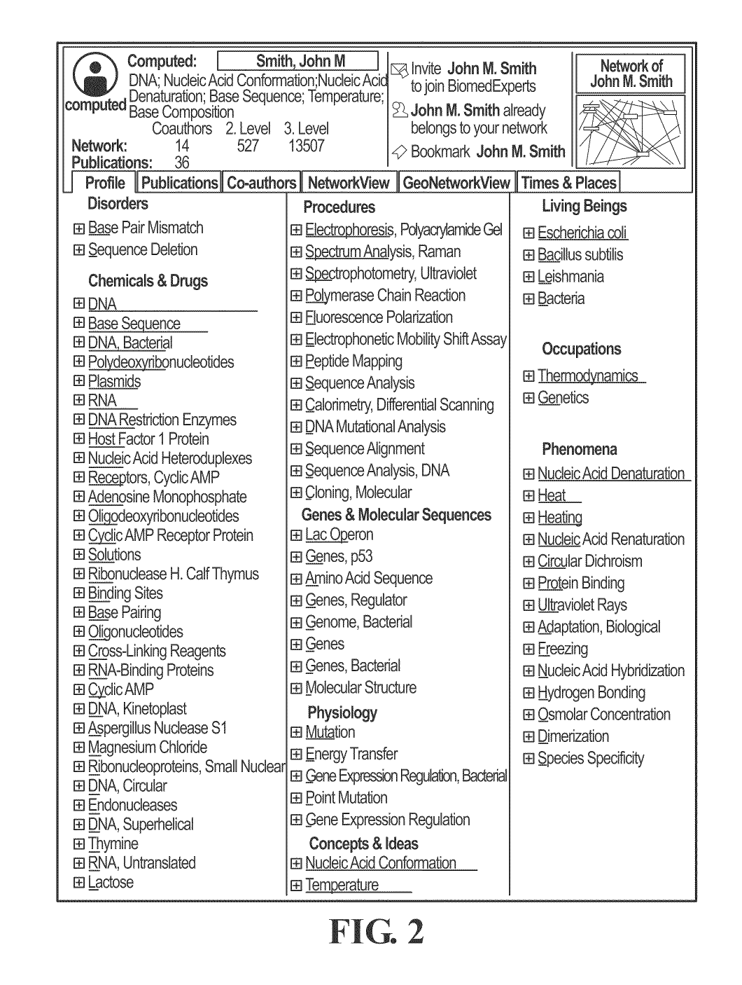

FIG. 2 illustrates an exemplary profile. The profile indicates the knowledge base of the user based on a search and analysis of publications by the user. In this example, medical concepts are used that were extracted from the user's publications.

The medical concepts are MeSH (Medical Subject Headings) and are ranked by their frequency in the publications and corrected by the IDF (Inverse Document Frequency) of the concept in the whole database (Pubmed). The concepts give an indication of which fields of expertise the user is active in.

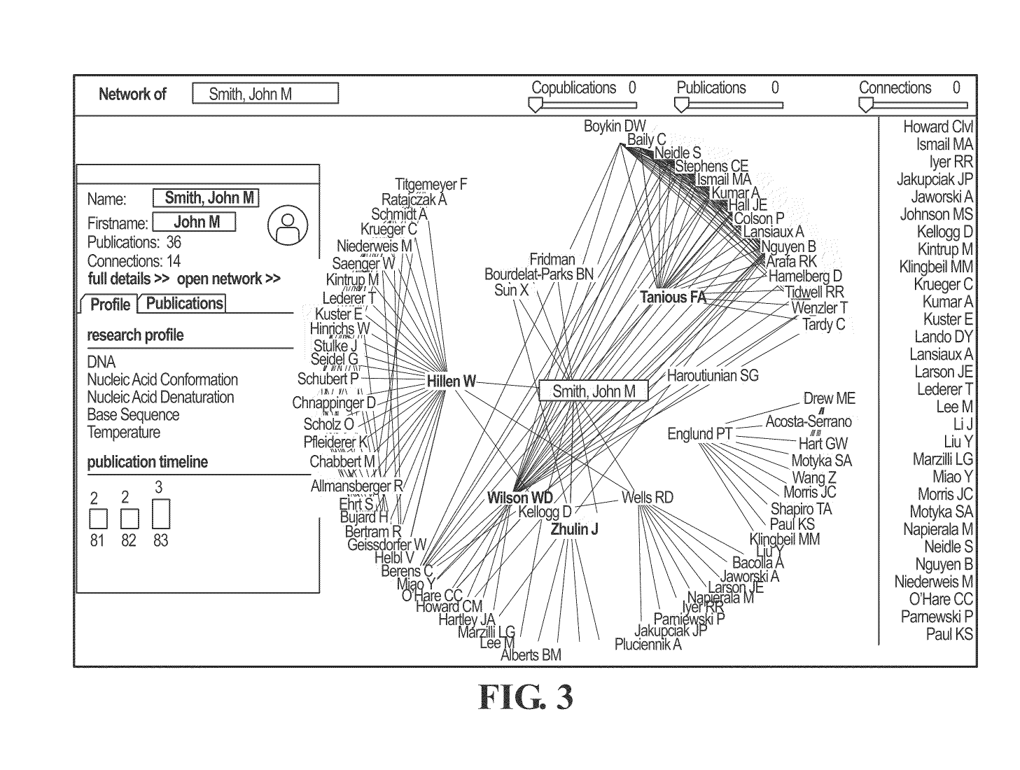

FIG. 3 illustrates an exemplary graph of a social network. The graph indicates the connections the user has to others. The connections indicate co-authorship between the two people connected. The connection is weighted by the number of common publications.

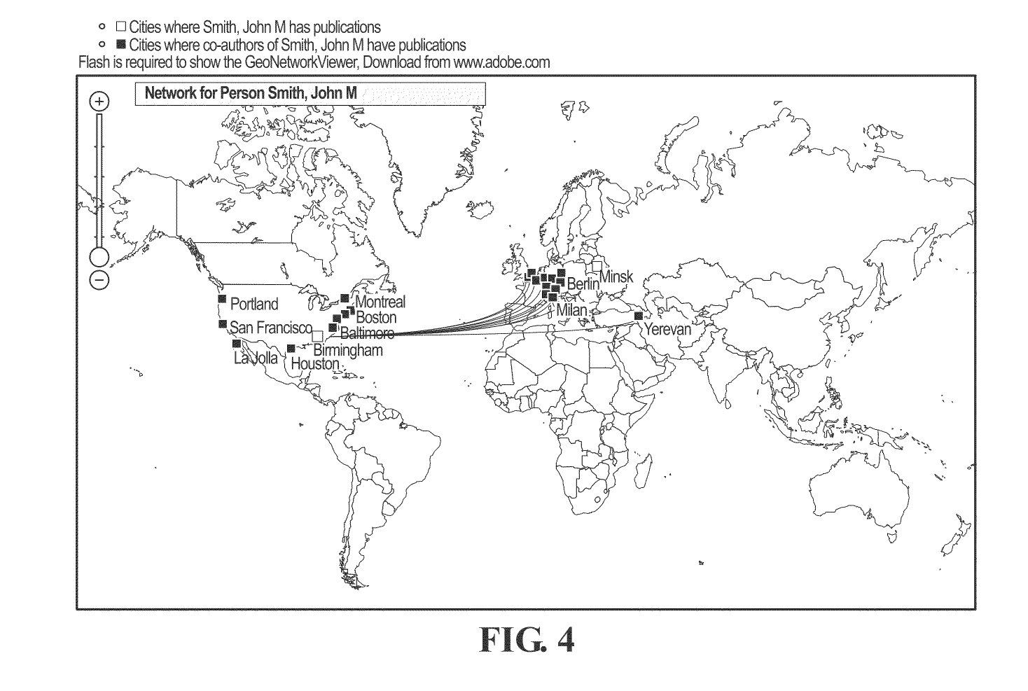

FIG. 4 illustrates an exemplary geographic map of a social network. The geographic map illustrates various locations throughout the world that the user is connected to. The lines are connections between a predicted activity center of the user (calculated based on location information statistics of the publications of the user) and cities where either the user himself was active or one of the people in the user's network were active.

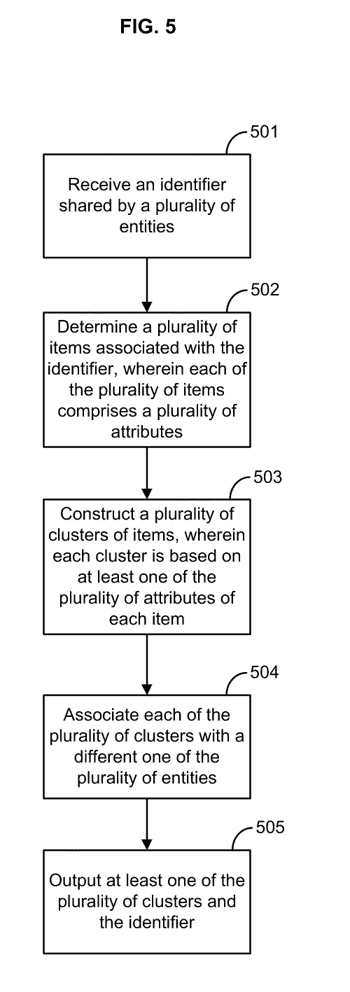

In an aspect, illustrated in FIG. 5, provided are methods for disambiguation, comprising receiving an identifier shared by a plurality of entities at 501, determining a plurality of items associated with the identifier, wherein each of the plurality of items comprises a plurality of attributes at 502, constructing a plurality of clusters of items, wherein each cluster is based on at least one of the plurality of attributes of each item at 503, associating each of the plurality of clusters with a different one of the plurality of entities at 504, and outputting at least one of the plurality of clusters and the identifier at 505.

For example, the identifier can be a name and the plurality of entities can be people, the identifier can be a word and the plurality of entities can be concepts, the identifier can be a name and the plurality of entities can be organizations, the identifier can be a word and the plurality of entities can be products, the identifier can be a word and the plurality of entities can be locations. In further aspects, identifiers can be a plurality of words.

The plurality of items can be at least one of, publications, patents, court cases, product descriptions, research proposals, grant descriptions, and the like. The plurality of attributes can comprise two or more of name, co-authorship, institution, location, concept, publication, publication date, birthday, and the like.

In an aspect, constructing a plurality of clusters of items, wherein each cluster is based on at least one of the plurality of attributes of each item can comprise comparing a first of the plurality of items to the remaining plurality of items, determining if a similarity is above a predetermined threshold, and clustering the items having a similarity above the predetermined threshold. The methods can further comprise comparing a first of the plurality of clusters to the remaining plurality of clusters, determining if a similarity is above a predetermined threshold, and clustering the clusters having a similarity above the predetermined threshold.

In an aspect, determining a plurality of items associated with the identifier, wherein each of the plurality of items comprises a plurality of attributes can comprise searching a third party publication database. Searching the third party database can comprise searching with a plurality of combinations of the identifier.

The at least one of the plurality of attributes can be co-author and the co-author can have been previously disambiguated.

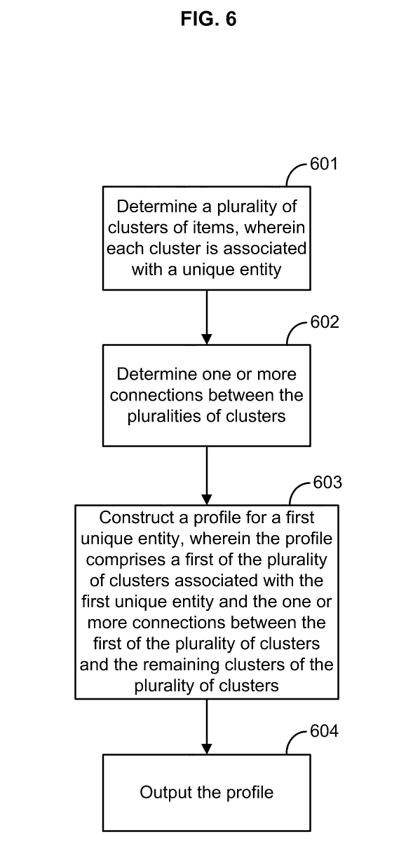

In another aspect, illustrated in FIG. 6, provided are methods for social networking, comprising determining a plurality of clusters of items, wherein each cluster is associated with a unique entity at 601, determining one or more connections between the pluralities of clusters at 602, constructing a profile for a first unique entity, wherein the profile comprises a first of the plurality of clusters associated with the first unique entity and the one or more connections between the first of the plurality of clusters and the remaining clusters of the plurality of clusters at 603, and outputting the profile at 604.

In an aspect, determining a plurality of clusters of items, wherein each cluster is associated with a unique entity can comprise receiving an identifier shared by a plurality of entities, determining a plurality of items associated with the identifier, wherein each of the plurality of items comprises a plurality of attributes, constructing a plurality of clusters of items, wherein each cluster is based on at least one of the plurality of attributes of each item, associating each of the plurality of clusters with a different one of the plurality of entities, and outputting at least one of the plurality of clusters and the identifier.

For example, the identifier can be a name and the plurality of entities can be people, the identifier can be a word and the plurality of entities can be concepts, the identifier can be a name and the plurality of entities can be organizations, the identifier can be a word and the plurality of entities can be products, the identifier can be a word and the plurality of entities can be locations. In further aspects, identifiers can be a plurality of words.

The plurality of items can be at least one of, publications, patents, court cases, product descriptions, research proposals, grant descriptions, and the like. The plurality of attributes can comprise two or more of name, co-authorship, institution, location, concept, publication, publication date, birthday, and the like.

In an aspect, determining one or more connections between the pluralities of clusters can comprise determining a commonality between clusters and storing the commonality as a connection between clusters.

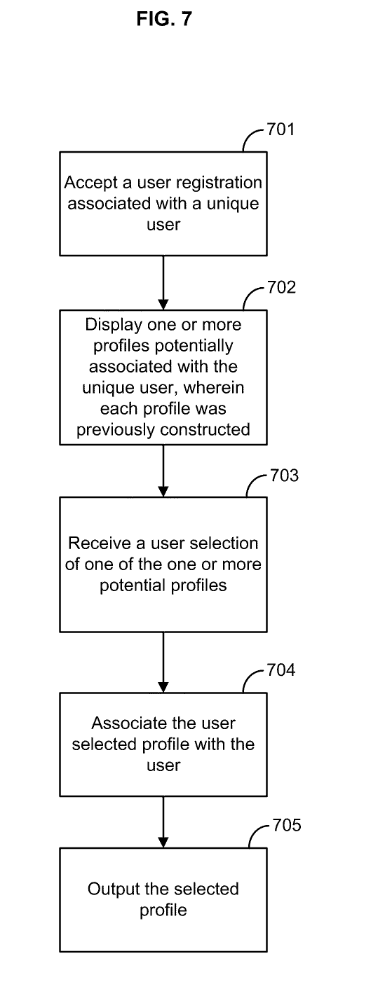

In another aspect, illustrated in FIG. 7, provided are methods for social networking, comprising accepting a user registration associated with a unique user at 701, displaying one or more profiles potentially associated with the unique user, wherein each profile was previously constructed at 702, receiving a user selection of one of the one or more potential profiles at 703, associating the user selected profile with the user at 704, and outputting the selected profile at 705. Accepting the user registration can be performed over a website.

In an aspect, each of the one or more profiles can be previously constructed by performing steps comprising determining a plurality of clusters of items, wherein each cluster is associated with a unique entity, determining one or more connections between the pluralities of clusters, constructing a profile for a first unique entity, wherein the profile comprises a first of the plurality of clusters associated with the first unique entity and the one or more connections between the first of the plurality of clusters and the remaining clusters of the plurality of clusters, and outputting the profile.

In an aspect, determining a plurality of clusters of items, wherein each cluster is associated with a unique entity can comprise receiving an identifier shared by a plurality of entities, determining a plurality of items associated with the identifier, wherein each of the plurality of items comprises a plurality of attributes, constructing a plurality of clusters of items, wherein each cluster is based on at least one of the plurality of attributes of each item, associating each of the plurality of clusters with a different one of the plurality of entities, and outputting one of the plurality of clusters and the identifier.

For example, the identifier can be a name and the plurality of entities can be people, the identifier can be a word and the plurality of entities can be concepts, the identifier can be a name and the plurality of entities can be organizations, the identifier can be a word and the plurality of entities can be products, the identifier can be a word and the plurality of entities can be locations. In further aspects, identifiers can be a plurality of words.

The plurality of items can be at least one of, publications, patents, court cases, product descriptions, research proposals, grant descriptions, and the like. The plurality of attributes can comprise two or more of name, co-authorship, institution, location, concept, publication, publication date, birthday, and the like.

In an aspect, determining one or more connections between the pluralities of clusters can comprise determining a commonality between clusters and storing the commonality as a connection between clusters.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for disambiguation, comprising:
receiving an identifier shared by a plurality of entities;
determining a plurality of items associated with the identifier, wherein each of the plurality of items comprises a plurality of attributes;
constructing a plurality of clusters of items, wherein each cluster is based on at least one of the plurality of attributes of each item;
associating each of the plurality of clusters with a different one of the plurality of entities; and
outputting one of the plurality of clusters and the identifier.

2. The method of claim 1, wherein the identifier is a name and the plurality of entities are people.

3. The method of claim 1, wherein the plurality of items are publications.

4. The method of claim 1, wherein the plurality of attributes comprises two or more of the following, name, co-authorship, institution, location, concept, and journal.

5. The method of claim 1, wherein constructing a plurality of clusters of items, wherein each cluster is based on at least one of the plurality of attributes of each item comprises:
comparing a first of the plurality of items to the remaining plurality of items;
determining if a similarity is above a predetermined threshold; and
clustering the items having a similarity above the predetermined threshold.

6. The method of claim 5, further comprising:
comparing a first of the plurality of clusters to the remaining plurality of clusters;
determining if a similarity is above a predetermined threshold; and
clustering the clusters having a similarity above the predetermined threshold.

7. The method of claim 1, wherein determining a plurality of items associated with the identifier, wherein each of the plurality of items comprises a plurality of attributes comprises searching a third party publication database.

8. The method of claim 7, wherein search the third party database comprises searching with a plurality of combinations of the identifier.

9. The method of claim 1, wherein the at least one of the plurality of attributes is co-author and the co-author has been previously disambiguated.

10. A method for social networking, comprising:
determining a plurality of clusters of items, wherein each cluster is associated with a unique entity;
determining one or more connections between the pluralities of clusters;
constructing a profile for a first unique entity, wherein the profile comprises a first of the plurality of clusters associated with the first unique entity and the one or more connections between the first of the plurality of clusters and the remaining clusters of the plurality of clusters; and
outputting the profile.

11. The method of claim 10, wherein determining a plurality of clusters of items, wherein each cluster is associated with a unique entity comprises:
receiving an identifier shared by a plurality of entities;
determining a plurality of items associated with the identifier, wherein each of the plurality of items comprises a plurality of attributes;
constructing a plurality of clusters of items, wherein each cluster is based on at least one of the plurality of attributes of each item;
associating each of the plurality of clusters with a different one of the plurality of entities; and
outputting one of the plurality of clusters and the identifier.

12. The method of claim 11, wherein the identifier is a name and the plurality of entities are people.

13. The method of claim 11, wherein the plurality of items are publications.

14. The method of claim 11, wherein the plurality of attributes comprises two or more of the following, name, co-authorship, institution, location, concept, and journal.

15. The method of claim 11, wherein determining one or more connections between the pluralities of clusters comprises:
determining a commonality between clusters; and
storing the commonality as a connection between clusters.

16. A method for social networking, comprising:
accepting a user registration associated with a unique user;
displaying one or more profiles potentially associated with the unique user, wherein each profile was previously constructed;
receiving a user selection of the one or more potential profiles;
associating the user selected profile with the user; and
outputting the selected profile.

17. The method of claim 16, wherein accepting the user registration is performed over a website.

18. The method of claim 16, wherein each of the one or more profiles was previously constructed by performing steps comprising:
determining a plurality of clusters of items, wherein each cluster is associated with a unique entity;
determining one or more connections between the pluralities of clusters;
constructing a profile for a first unique entity, wherein the profile comprises a first of the plurality of clusters associated with the first unique entity and the one or more connections between the first of the plurality of clusters and the remaining clusters of the plurality of clusters; and
outputting the profile.

19. The method of claim 16, wherein determining a plurality of clusters of items, wherein each cluster is associated with a unique entity comprises:
receiving an identifier shared by a plurality of entities;
determining a plurality of items associated with the identifier, wherein each of the plurality of items comprises a plurality of attributes;
constructing a plurality of clusters of items, wherein each cluster is based on at least one of the plurality of attributes of each item;
associating each of the plurality of clusters with a different one of the plurality of entities; and
outputting one of the plurality of clusters and the identifier.

20. The method of claim 19, wherein the identifier is a name and the plurality of entities are people.

21. The method of claim 19, wherein the plurality of items are publications.

22. The method of claim 19, wherein the plurality of attributes comprises two or more of the following, name, co-authorship, institution, location, concept, and journal.

23. The method of claim 19, wherein determining one or more connections between the pluralities of clusters comprises:
determining a commonality between clusters; and
storing the commonality as a connection between clusters.
